(19) United States
(12) Patent Application Publication
(10) Pub. No.: US 2015/0204298 A1
(43) Pub. Date: Jul. 23, 2015

(54) Blade for a Water Turbine

(71) Applicant: Voith Patent GmbH, Heidenheim (DE)

(72) Inventors: Ingrid Reh, Spabrucken (DE); Günther Horn, Heidenheim (DE)

(73) Assignee: Voith Patent GmbH, Heidenheim (DE)

(21) Appl. No.: 14/400,764

(22) PCT Filed: Oct. 18, 2013
(86) PCT No.: PCT/EP2013/071860

§ 371 Date: Nov. 12, 2014

(30) Foreign Application Priority Data
Dec. 4, 2012 (DE) 10 2012 023 617.4

(51) Int. Cl. F03B 3/12

(52) U.S. Cl. CPC F03B 3/121

(57) ABSTRACT

The invention relates to a blade (1.1) for a water turbine, comprising the following features or components: •—a body made of sheet steel or cast steel, said body having mutually opposite outer surfaces that are in contact with the water during operation; •—at least one relief notch (5) which is located in a peripheral region of the blade (1.1) and extends through mutually opposite regions of the outer surfaces; •—a curable filling compound (6) which fills the cavity in the notch (5). The invention is characterized by the following features: •—retaining bodies (10) are fixed to the notch surface (5.1), said retaining bodies (10) being embedded in the filling compound (6) in the mounted state; •—the retaining bodies (10) have protrusions which prevent the filling compound (6) from falling out by way of a tight fit when the filling compound has cured.

The invention concerns water turbines, in particular axial water turbines, for instance Kaplan turbines. See for instance DE 101 00 963 A1.

Such a turbine comprises as essential parts an impeller, a guide wheel as well as a housing. The impeller includes a shaft as well as a number of blades, which are carried by the shaft and rotate therewith. The blades are generally adjustable around rotational axes, which run perpendicular to the longitudinal axis of the shaft.

The purpose of the adjustment of the blades is to optimise the degree of efficiency of the turbine and indeed beyond the whole working area. Moreover, the cavitation will be reduced or avoided according to said adjustment.

The cavitation has always raised a serious problem. It occurs at places where the static pressure of the flow sinks while the flow velocity increases. This is for instance the case in the foot region of a blade where the so-called notch stress appears.

To avoid any notch stress, it is known to provide a notch in the material and hence a recess which avoid sharp contour modifications and instead of that creates soft transitions of the contour.

Blades for water turbines consist of cast steel. They are consequently quite massive.

Admittedly, the cutting out of the relief notch eliminates the danger of high notch stress to a vast extent. The cavity forming the notch is however disadvantageous since it causes disturbances of the flow and thus reduces the degree of efficiency of the turbine. To do so, the notch is filled with a filling compound. Consequently, the surface of the filling compound is treated and polished. This operation enables to restore the old contour of the blade, i.e. the contour of the relief notch before cutting out.

The Object is Satisfied as Follows:

The disadvantageous effects of the notch, namely the notch stress, are avoided and the blade is flowed around even in the notch area, as if there were to relief notch at all. But it has given rise to another problem: The fixation of the filling compound in the notch is labour intensive and moreover not reliable. It should be noted that there is the danger that the filling compound does not fall out from the notch during operation, either in whole or in part, in particular in the discharge area of the filling compound, where the layer thickness is minimum.

The object of the invention is then to configure a blade for a water turbine according to the preamble of claim in such a way that the filling compound can be fixed reliably and durably and without interference with the flow at the production of the relief notch.

Said object is met by the features if the independent claims. The most salient features are as follows:

The notch surface is fitted with retaining bodies said bodies being imbedded in the filling compound in the mounted state;

Said retaining bodies have protrusions, which prevent the filling compound from falling out once the filling compound has cured.

The retaining bodies are preferably pins or bolts or screws. Said bodies are connected rigidly with the notch surface of the blade, for instance by welding. Screws are ideally to a certain extent as they do not require further treatment. The thread and screw heads enable the filling compound to sink in position.

Also, pin-shaped retaining bodies can be provided, which are bent at right angle. A further solution consists in providing two or more pin-shaped retaining bodies in such a way that they prevent the filling compound from falling out due to the different orientation of their longitudinal axis.

The state of the art as well as the invention will be better understood with reference to the drawing. The following details are shown:

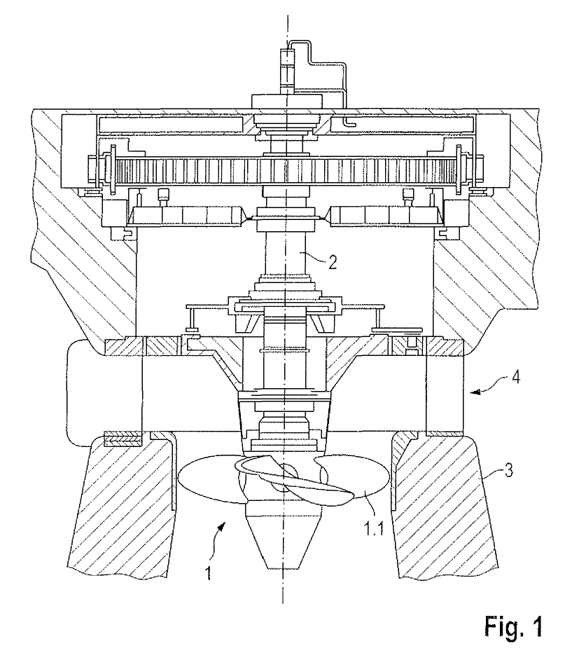

FIG. 1 shows a known Kaplan turbine with adjustable blades in elevation view and partially as in section.

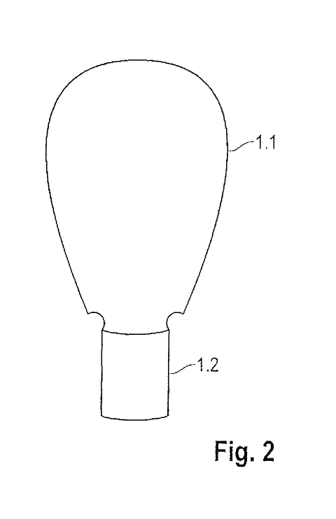

FIG. 2 shows a diagrammatic illustration of a blade in elevation view with blade foot and not-filled relied notches.

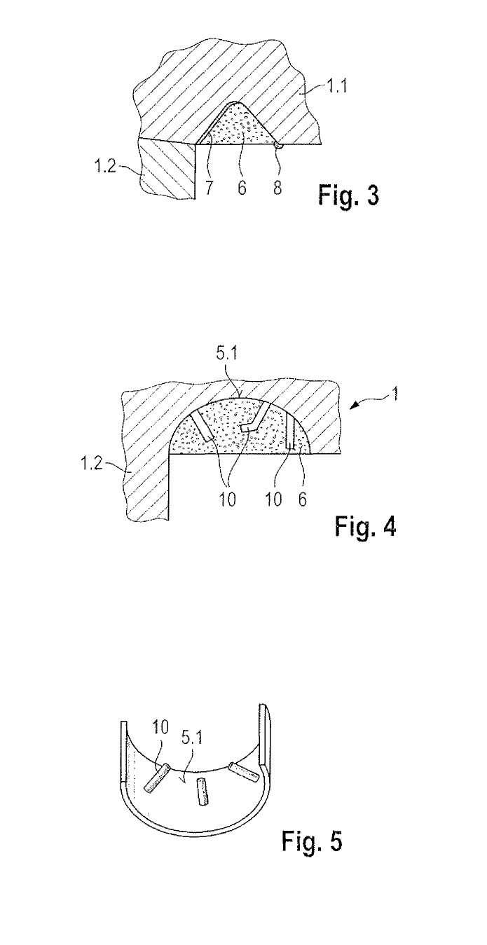

FIG. 3 shows again according to the state of the art a blade with a blade foot and filled relief notch.

FIG. 4 shows a form of embodiment according to the invention with a blade, a foot, a filling compound and screws of the retaining body.

FIG. 5 shows in a 3D-view a notch surface according to the invention with retaining bodies.

The Kaplan turbine shown in FIG. 1 includes an impeller 1, which is carried by a shaft 2. The shaft 2 is arranged vertically. The impeller includes adjustable blades 1.1.

The impeller is enclosed by a current-carrying wall 3. A guide blade crown 4 is moreover provided. It is installed in the wall 3. The guide blades 4.1 are also adjustable.

Adjustment is performed by an adjustment unit according to the invention which enables to apply an adjusting force which is proportional to the falling height.

FIG. 2 shows a conventional blade 1.1 of a Kaplan turbine with a blade foot 1.2. The blade 1.1 includes two relief notches 5 in the foot area. Said relief notches are not filled yet with a filling compound.

FIG. 3 illustrates a known form of embodiment with a rotor blade 1.1, a rotor blade foot 1.2 and with a filling compound 6. The filling compound 6 is glued with the base of the relief notch 5 through an epoxy resin layer 7 and is moreover welded once again with the blade 1.1—see welding seam 8.

FIG. 4 is a very diagrammatical illustration of a blade foot 1.1 according to the invention, with a blade 1.2, filling material 6 and retaining bodies 10. The filling compound 6 consists of a curable material, for instance a two-component adhesive or a polymer material. It contains moreover a fibre entanglement, for instance made of metal yarns.

FIG. 4 shows the notch surface 5.1. It represents a circular segment in this view. With respect to the blade 1.2, it is annular. The retaining bodies are screws 10 in the present case. They are welded to the notch face 5.1 with one of their ends.

In the mounted state, the screws 10 reach into the filling compound 6, they are embedded therein fully and sink their claws in the fibre entanglement so that the filling compound is fixed reliably after the filling compound has cured.

The screws are oriented along various angles and all the more so since they together prevent the filling compound 6 from falling out.

### LIST OF REFERENCE SIGNS

1 Impeller

1.2 Blade

2 Shaft

3 Wall

4 Guide blade crown

4.1 Guide blade

5 Relief notch

5.1 Notch face

6 Filling compound

7 Epoxy resin layer

8 Welding seam

10 Retaining body

1-5. (canceled)

6. A blade for a water turbine, the blade comprising:
a body made of sheet steel or of cast steel, said body having mutually opposite outer faces which are in contact with the water during operation;
at least one relief notch, which is located in a peripheral region of the blade and which extends through mutually opposite regions of the outer faces;
a curable filling compound, which fills the cavity of the notch;
wherein retaining bodies are fixed to the notch surface, said retaining bodies being imbedded in the filling compound in the mounted state, and wherein said retaining bodies have protrusions, which prevent the filling compound from falling out once said filling compound has cured.

7. The blade according to claim 6, wherein a fibre entanglement is embedded into the filling compound.

8. The blade according to claim 6, wherein the retaining bodies consist of screws.

9. The blade according to claim 7, wherein the retaining bodies consist of screws.

10. The blade according to claim 6, wherein the retaining bodies are pin-shaped and bent at right angle.

11. The blade according to claim 7, wherein the retaining bodies are pin-shaped and bent at right angle.

12. The blade according to claim 8, wherein the retaining bodies are pin-shaped and bent at right angle.

13. The blade according to claim 9, wherein the retaining bodies are pin-shaped and bent at right angle.

14. The blade according to claim 6, wherein the filling compound is a synthetic material, for instance a two-component adhesive or a polymer.

15. The blade according to claim 7, wherein the filling compound is a synthetic material, for instance a two-component adhesive or a polymer.

16. The blade according to claim 8, wherein the filling compound is a synthetic material, for instance a two-component adhesive or a polymer.

17. The blade according to claim 9, wherein the filling compound is a synthetic material, for instance a two-component adhesive or a polymer.

18. The blade according to claim 10, wherein the filling compound is a synthetic material, for instance a two-component adhesive or a polymer.

19. The blade according to claim 11, wherein the filling compound is a synthetic material, for instance a two-component adhesive or a polymer.

20. The blade according to claim 12, wherein the filling compound is a synthetic material, for instance a two-component adhesive or a polymer.

21. The blade according to claim 13, wherein the filling compound is a synthetic material, for instance a two-component adhesive or a polymer.
